(19) United States
(12) Patent Application Publication
(10) Pub. No.: US 2023/0031197 A1
(43) Pub. Date: Feb. 2, 2023

(54) TOWER STRUCTURE OF A PRE-HEATING TOWER OF A PLANT FOR THERMALLY PROCESSING MINERALS, AND METHOD FOR CONSTRUCTING THE PRE-HEATING TOWER

(71) Applicants: thyssenkrupp Industrial Solutions AG, Essen (DE); thyssenkrupp AG, Essen (DE)

(72) Inventors: Michael MENNE, Bochum (DE); Reinhard GIESEMANN, Harsewinkel (DE); Edib BEN TALEB, Kamen (DE); Thomas RUETHER, Drensteinfurt (DE)

(73) Assignees: thyssenkrupp Industrial Solutions AG, Essen (DE); thyssenkrupp AG, Essen (DE)

(21) Appl. No.: 17/784,487

(22) PCT Filed: Dec. 9, 2020
(86) PCT No.: PCT/EP2020/085277

§ 371 Date: Jun. 10, 2022

(30) Foreign Application Priority Data
Dec. 12, 2019 (BE) BE2019/5898
Dec. 12, 2019 (DE) 10 2019 219 499.0

(51) Int. Cl. E04H 12/34

(52) U.S. Cl. CPC E04H 12/34; E04H 12/08

(57) ABSTRACT

A tower structure of a pre-heating tower of a plant for thermally processing minerals may include a plurality of support beams that extend vertically and parallel to one another and are connected to one another via cross beams. The tower structure may further include a plurality of mounting positions, each mounting position for fitting a platform to the tower structure. A cross-sectional profile of at least two of the support beams changes over a height of the tower structure. Further, at least two adjacent support beams may be configured such that there is a greater amount of space between the beams at a bottom end region of the adjacent support beams than at a region above the bottom end region.

The invention relates to a tower structure of a pre-heating tower of a plant for thermally processing minerals. The invention also relates to a pre-heating tower having such a tower structure and a plurality of platforms, as well as to a method for constructing the pre-heating tower.

In the cement industry, multi-floor pre-heating towers are constructed for pre-heating the raw mix, prior to the mix being loaded into the kiln. For example, in the case of a 6-stage pre-heater, 8 to 9 platforms are usually provided so that the tower construction can reach a height of 160-170 m. The construction period of the pre-heating tower is particularly time intensive and usually requires 14 to 19 months. The completion deadline of a cement plant is therefore determined substantially by the period of time required for the construction of the pre-heating tower. According to the prior art, the pre-heating tower is embodied in concrete or steel, wherein the individual platforms are successively mounted from the bottom to the top, and the machinery is lifted into the tower using large heavy-duty cranes. The profiles of the platform here are lifted up individually or in pre-assembled units and mounted so as to form the platforms. The same procedure is carried out with the components of the machinery. The lining material required for specific components is transported to the respective platforms in the tower construction, for example by way of a goods elevator and with the support of winches and large cranes, onward manual transportation and subsequent installation taking place from said respective platforms.

The current method is time-consuming and expensive as a result of the use of expensive large cranes and of many overhead lifting maneuvers into the building for steel and equipment. These maneuvers are also associated with a risk of accident that cannot be neglected.

The invention is therefore based on the object of developing a pre-heating tower and a method for constructing such a pre-heating tower, by way of which the construction time and the assembly time can be significantly shortened.

This object is achieved according to the invention by a tower structure of a pre-heating tower, having the features of the independent device claim 1, and by a method for constructing a pre-heating tower, having the features of the independent method claim 9. Advantageous refinements are derived from the dependent claims.

According to a first aspect, a tower structure of a pre-heating tower of a plant for thermally processing minerals comprises a plurality of support beams which extend vertically and parallel to one another and are connected to one another via cross beams. The support beams are in particular supports which extend exclusively in the vertical direction. Furthermore, the tower structure comprises a plurality of mounting positions, in each case for fitting a platform to the tower structure. The cross-sectional profile of at least two of the support beams changes over the height of the tower structure, in particular over the length of the support beams.

The plant for thermally processing minerals is, for example, a cement production plant having a pre-heater, adjoining thereto a kiln, and a cooler for cooling the clinker exiting the oven. A pre-heating tower preferably has a plurality of cyclones which are successively disposed, for example in five cyclone stages, and serve for separating solids and gas. The cyclones are connected to one another by way of pipelines for directing raw mix and/or kiln exhaust gas. Raw mix is input into the uppermost cyclone stage during operation of the preheater. The raw mix such as, for example, a mineral material such as limestone, passes the individual cyclone stages from the top to the bottom and in the process is preheated in the kiln exhaust gas counterflow. The kiln exhaust gas enters the pre-heater from below, i.e. enters the last or lowermost cyclone stage, and flows through the individual cyclone stages from the bottom toward the top, said kiln exhaust gas being cooled by the raw mix by way of the heat exchange. A calciner which has a burner installation and ensures that the raw mix is additionally neutralized and calcinated prior to entering the kiln is optionally disposed between the last and the penultimate cyclone stage.

The tower structure is configured from concrete and/or steel, for example, and preferably comprises only the structural elements of the building. The support beams are preferably configured in each case in an integral manner, for example from steel and/or concrete, and extend in particular from the ground floor to the uppermost floor of the tower structure. For example, the support beams have in each case a cross-sectional profile which is configured so as to be H-, T-, L-, I- O- or U-shaped. Two adjacent support beams preferably have a cross-sectional profile which changes as the height of the tower structure changes. The cross-sectional profiles of the two adjacent support beams preferably change in an identical manner. The support beams are preferably disposed at the corners of the tower structure and configure the external edges of the tower structure.

The mounting positions are understood to be those positions on the tower structure where platforms can be fitted, said platforms configuring an entire floor or parts of a floor of the pre-heating tower, for example. The mounting positions are preferably mutually disposed over the height, in particular so as to be uniformly spaced apart. The tower structure at the mounting position thereof preferably comprises in each case fastening installations such as bores or mountings for fastening the platform to the tower structure. The mounting positions correspond in particular to the positions of the respective floors/stories of the tower structure, in particular of the pre-heating tower, wherein the lowermost mounting position is the first mounting position, and the mounting position lying thereabove is the second mounting position.

The cross beams preferably extend in each case between two adjacent support beams. In particular, the cross beams extend at least partially or completely horizontally, preferably so as to be orthogonal to the support beams. The mounting positions are in each case preferably disposed on a cross beam or at the height level of at least one cross beam. This serves in particular for reinforcing the tower structure.

A changing cross-sectional profile of at least two, in particular adjacent, support beams offers the advantage that the spacing between two support beams varies over the height of the tower structure without causing any significant weakening of the load-bearing capability or increasing the complexity of the construction.

According to a first embodiment, at least two support beams each have a first and a second cross-sectional profile, wherein the first cross-sectional profile is configured on the lower end region of the support beam. The two support beams preferably have exclusively two cross-sectional profiles, specifically a lower and an upper cross-sectional profile.

According to a further embodiment, the first cross-sectional profile is configured below a first or second mounting position. The first cross-sectional profile at the height level of the first or second mounting position preferably transitions into the second cross-sectional profile. The first-cross-sectional profile is in particular configured exclusively below the first or second mounting position. The first or the second mounting position is understood to be the position of the first or the second floor of the pre-heating tower.

According to a further embodiment, the first cross-sectional profile of two adjacent support beams is configured in such a manner that the spacing between the support beams is greater below the first or second mounting position than above the latter. The spacing forms in particular a push-in region for pushing in a platform, wherein the spacing corresponds approximately to the width of the platform. An enlarged spacing of the support beams offers the advantage that a completely assembled platform can be pushed into the tower structure from the outside. An assembly of the platform within the tower structure is thus no longer necessary.

The first and/or the second cross-sectional profile are/is preferably an H, T, L, I, O or U. For example, the first cross-sectional profile in relation to the second cross-sectional profile is rotated by approximately 90° about the longitudinal axis of the support beam. For example, the first cross-sectional profile has an angle section having two legs, wherein one of the legs points outward.

According to a further embodiment, a dismountable cross beam or no cross beam is fitted below the second mounting position between the support beams with the cross-sectional profiles which changes over the length. At least two support beams have preferably no cross beams below the second mounting position. For example, only three cross beams are fitted at the height level of the first mounting position. For example, the tower structure is configured in such a manner that the spacing of the first and the second mounting position is greater than the height of the platform. In particular, the spacing of the first and the second mounting position is approximately 1 m to 6 m, preferably 2 m to 5 m, in particular 4 m. The absence of one of the cross beams enables an assembled platform to be pushed into the tower structure, despite the height of the platform exceeding the height of the floor.

The invention also comprises a pre-heating tower of a plant for thermally processing minerals, having a tower structure as described above and a plurality of platforms, wherein each platform has a base plate and at least one cyclone fitted thereon, and wherein in each case one platform is fitted at a mounting position of the tower structure. For example, the platform has at least one pipeline for directing material and/or kiln exhaust air. In the assembled state, each platform preferably configures a complete floor, or at least part of a floor, of the pre-heating tower.

According to one embodiment, the height of the platform exceeds the vertical spacing between two adjacent mounting positions of the tower structure. According to a further embodiment, the platform has a cross beam which is fitted between the two support beams with a cross-sectional profile which changes over the length. The cross beam is preferably fastened to the platform and, conjointly with the latter, is fitted to the tower structure.

The invention also comprises a method of constructing a pre-heating tower of a plant for thermally processing minerals as described above, said method comprising the steps of:

a. constructing or using a tower structure as described above, having a plurality of mounting positions for the fastening of platforms, each of which at least partially or completely configures a floor of the pre-heating tower,
b. assembling at least one platform below its mounting position,
c. raising the assembled platform as far as an upper mounting position,
d. mounting the platform at an upper mounting position so that the platform configures an upper floor of the pre-heating tower;
e. raising a further platform as far as a mounting position below the platform mounted in step d., and
f. mounting the further platform at the mounting position so that the further platform configures a further floor of the pre-heating tower.

The advantages and embodiments described in the context of the tower structure and the pre-heating tower in a manner analogous to the method also apply to the method for constructing a pre-heating tower of a plant for thermally processing minerals. Steps a to f are preferably performed in succession.

Step a preferably comprises the complete construction of the tower structure such that mounting of the platforms is possible. The mounting of the platform is understood to be the connecting of the platform to the tower structure. The construction of the tower structure preferably takes place by the slip-form construction mode and/or by the climbing-form construction mode from concrete and/or steel. The construction of the platform according to method step b takes place by assembling profiles of steel and/or concrete.

The raising of the platforms as far as the respective installation position thereof in the tower structure according to method step e expediently takes place by means of strand jacks and/or rope hoists and/or pneumatic and/or hydraulic lifting tools. According to the invention it is furthermore provided that at least three, preferably at least four or more, platforms are incorporated in the building structure. The tower structure here can be constructed so as to have a height above ground of at least 50 m, preferably of at least 80 m, and most preferably of at least 100 m.

According to a further embodiment the in particular complete assembly of the platform is realized at a level below the lowermost mounting position, preferably at base level. The assembly of the platform according to a further embodiment is realized at base level within the tower structure.

The substantial difference in comparison to the practice to date when constructing a multi-floor tower construction lies in that the individual platforms are constructed at a level below the mounting position of said platforms, in particular on the ground, or on mounting frames provided on the ground, and then are lifted into their construction position in the tower structure wherein the platforms, starting with an upper platform and working down to the lower platform, are gradually incorporated in the building structure. Since the construction of the platform substantially takes place on the ground, it is possible for a plurality of platforms to be simultaneously constructed. Since the construction of a platform requires more time than the installation of said platform, the assembly time is significantly shortened as a result of work being carried out in parallel on a plurality of platforms.

In order for the assembly time to be accelerated and for the construction to be facilitated, the platforms, expediently while the latter are still situated on the ground, are equipped with machinery provided for the respective platform. Said platforms can also be provided completely or partially with the required electrics and/or process control equipment. If individual parts of machines have to be provided with a fire-resistant cladding, the platforms can be equipped completely or partially with a fire-resistant cladding required for the respective platform, even while said platforms are still situated on the ground. The fire-resistant cladding here can be provided only on the platform, or already be installed in the corresponding machine parts.

According to a further embodiment the assembled platform is pushed laterally into the tower structure below the second mounting position, preferably below the first mounting position. The first mounting position is preferably understood to be the position of the first floor of the pre-heating tower, wherein the customary method of numbering of buildings is used here, the first floor being the lowermost floor above the ground floor. Optionally, prior to pushing-in, a cross beam below the second mounting position is removed from the tower structure. In particular, the cross beam which has the cross-sectional profile that changes over the height and which is fitted between the two support beams is removed. After the platforms have been mounted at the respective mounting positions thereof, the cross beam is preferably fitted back at the previous position of the latter. For example, the platform is assembled in such a manner that the height of the platform exceeds the spacing between two adjacent floors, in particular mounting positions, of the pre-heating tower.

According to a further embodiment the raising of the platform is realized within the tower structure, preferably completely within the tower structure, and in particular once the respective platform has been completely assembled within the tower structure. This has the advantage that the platform within the building structure can be raised upwardto the installed position of said platform, as a result of which a multiplicity of heavy-duty cranes that for raising the platforms are placed outside the tower construction can be fully dispensed with. Therefore, the building structure per se assumes the function of the cranes. The assembly time can also be significantly shortened as a result of this measure. Moreover, the occupational safety is clearly improved because the completely constructed platform on the ground merely has to be pushed into the building structure and is then raised in a straight upward manner as far as the installation position of said platform.

According to a further embodiment the assembly of at least one of the platforms comprises the mounting of at least one cyclone on a base structure.

According to a further embodiment the tower structure is realized by assembling profiles composed of steel or concrete so that the tower structure has a wider lateral push-in opening below the second mounting position, preferably below the first or second mounting position, than above the first or second mounting position.

### DESCRIPTION OF THE DRAWINGS

The invention is explained in more detail hereunder by means of a plurality of exemplary embodiments with reference to the appended figures in which:

FIG. 1 shows a schematic illustration of a pre-heating tower having a plurality of platforms according to one exemplary embodiment;

FIG. 2 shows a schematic illustration of a tower structure of a pre-heating tower in a perspective view, according to one exemplary embodiment;

FIG. 3 in a schematic illustration shows two exemplary embodiments of a tower structure in a cross-sectional view;

FIG. 4 in a schematic illustration shows a platform for fitting in a tower structure according to FIG. 3, in a lateral view according to one exemplary embodiment; and

FIG. 5 shows a schematic illustration of the platform of FIG. 4 in a plan view, according to one exemplary embodiment.

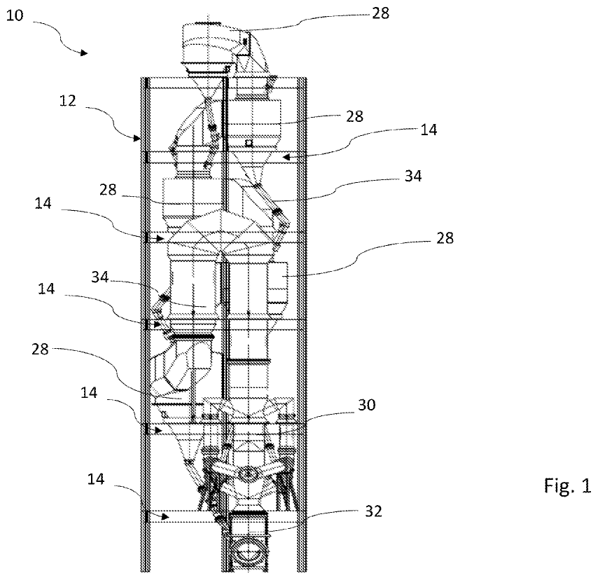

FIG. 1 shows a pre-heating tower 10 which is, for example, part of a plant for thermally processing materials such as a cement production plant, for example. The pre-heating tower 10 has a plurality of cyclones 28 which serve for separating gas and material. By way of example, four cyclone stages through which the raw material passes are illustrated in FIG. 1.

Furthermore, the pre-heating tower 10 has, for example, a calciner 30 which serves for neutralizing and pre-calcinating the material. Materials such as, for example, limestone, ore, clay or other mineral products are pre-heated and neutralized in the counterflow in the pre-heating tower 10, wherein heated exhaust gas from a kiln such as, for example, a rotary kiln, is introduced into the pre-heating tower from below and passes through a plurality of cyclones. The material to be heated is fed into the pre-heating tower 10 at the upper end and in the flow counter to the kiln exhaust gas passes through the plurality of cyclones. The cyclones 28 and the calciner 30 are preferably connected to one another by way of pipelines 34. The material, in particular the fired cement clinker, at the kiln outlet 32 has a temperature of approximately 1150-1450° C., preferably 1400° C.

The pre-heating tower 10 has a tower structure 12 and a plurality of platforms 14 which are fitted to the tower structure 12. By way of example, the pre-heating tower 10 has six platforms 14 which are disposed so as to be mutually spaced apart in the height of the tower. The platforms 14 are preferably aligned horizontally and mutually parallel and are in particular mutually spaced apart in a substantially uniform manner. Each platform 14 preferably configures a complete floor, or part of a floor, of the pre-heating tower 10.

The lowermost platform 14 comprises a kiln outlet 32 through which the hot kiln exhaust gas enters the pre-heating tower 10 and the pre-heated material exits the pre-heating tower 10 and enters the kiln.

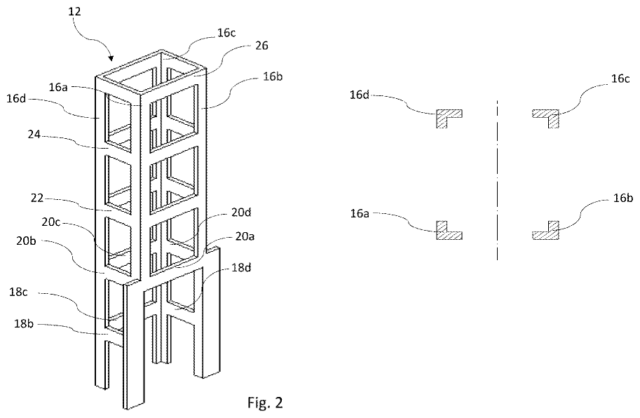

FIG. 2 shows the tower structure 12 of the pre-heating tower 10 without platforms and installations. By way of example, the tower structure 12 has for vertical support beams 16a-d which extend parallel to one another and configure the outer structural edges of the tower structure 12. The support beams 16a-d are connected to one another by way of cross beams 18-26. By way of example, the cross beams 18-26 extend horizontally so as to be substantially orthogonal to the support beams 16a-d. It is likewise conceivable that the cross beams 18-26 extend so as to have merely a partially horizontal component. Each cross beam 18-26 connects in each case two adjacent support beams 16a-d to one another. The tower structure 12 of FIG. 2, by way of example, at the height level of a respective floor of the pre-heating tower 10 has a cross beam group a-d having in each case a plurality of cross beams 18-26d. The tower structure 12 has a plurality of mounting positions on each of which one platform 14 can be fitted. Fastening means for fastening a respective platform 14 to the tower structure 12 in a respective mounting position are preferably disposed on the cross beams 18-26 and/or the support beams 16a-d.

The tower structure 12 has lateral openings, the width of the latter being delimited by the spacing of two adjacent support beams 16a-d. The height of the respective opening is determined by the mutual spacing of two adjacent cross beams 16-24, preferably two adjacent floors of the tower structure 12. The tower structure 12 preferably has a quadrangular cross section. By way of example, the support beams 16a-d have in each case one angle section which has an equal leg angle or an unequal leg angle. The support beams 16a-d are mutually aligned in such a manner, for example, that the angle sections, at least in the upper region of the tower structure 12, point outward and in each case configure the external corners of the tower structure 12.

By way of example, two support beams 16c and 16d over the entire length thereof have a constant cross-sectional profile, wherein two support beams 16a and 16b have a cross-sectional profile which changes over the length of the support beams 16a and 16b. FIG. 2 furthermore shows a cross section of the tower structure 12 which is configured in a region above the second floor of the tower structure 12. By way of example, all support beams 16a-d above the second floor of the tower structure 12 preferably have a constant cross-sectional profile. Furthermore, by way of example, the tower structure 12, on a lateral face of the tower structure below the second floor, does not have any cross beam. In each case one cross beam 18-26a-d is preferably fitted at the same height level on each lateral face at the remaining mounting positions and/or floors of the tower structure 12. The lowermost, first floor by way of example has only three cross beams 18b-d.

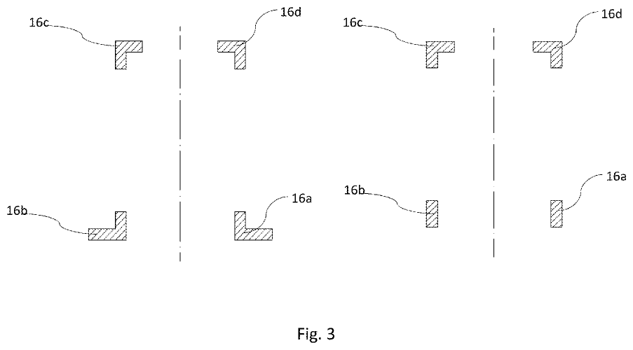

FIG. 3 shows two embodiments of a cross-sectional profile of the tower structure 12 below the second floor. Two of the support beams 16a and 16b by way of example have in each case one first cross-sectional profile and one second cross-sectional profile. For example, the first cross-sectional profile is disposed below the second floor, and the second cross-sectional profile is disposed above the second floor of the tower structure 12. The first and the second cross-sectional profile of a respective support beam 16a-b have identical cross-sectional faces, for example.

For example, the first cross-sectional profile is configured as an unequal angle section, wherein the longer of the two legs by way of example points outward and the shorter leg points in the direction of the adjacent support beam 16c or 16d. In the second exemplary embodiment of FIG. 3, the first cross-sectional profile of the adjacent support beams 16a and 16b has in each case a rectangular cross-sectional face, the latter corresponding to a leg of the angle section above the second floor of the tower structure 12, for example. The first cross-sectional profile of the adjacent support beams 16a and 16b is preferably configured and aligned in such a manner that the spacing of the adjacent support beams 16a and 16 below the second floor is greater than above the second floor of the tower structure 12. For example, the first cross-sectional profile in comparison to the second cross-sectional profile is rotated by, for example, 90° about the tip of the leg. The first cross-sectional profile at the height level of the second-floor transitions into the second cross-sectional profile so that the spacing between the adjacent support beams 16 and 16b above the second floor is smaller than below the second floor of the tower structure 12. The second cross-sectional profile of the support beams 16a and 16b is preferably configured as an equal-leg angle section.

FIG. 3 shows merely two examples of cross-sectional profiles of the support beams 16 below the second floor of the tower structure 12, wherein further embodiments are conceivable in which the lower cross-sectional profile of two adjacent support beams 16a and 16b is configured and aligned in such a manner that the mutual spacing of the support beams 16a and 16b is greater than above the second floor.

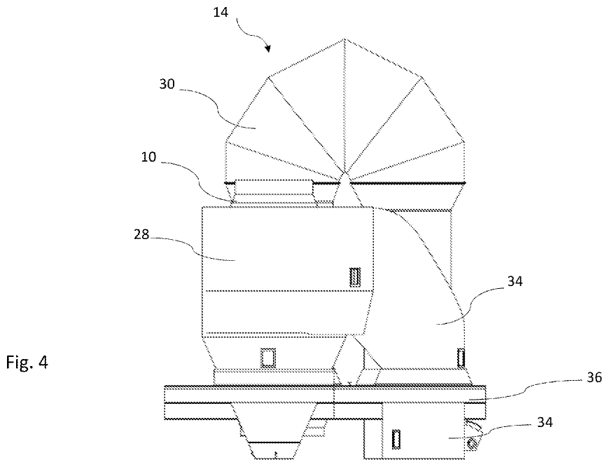

FIG. 4 shows a platform 14 for fitting to the tower structure 12. By way of example, the platform 14 comprises a base plate 36 which is configured, for example, as a floor grate or from a plurality of floor planks. The base plate 36 preferably has one or a plurality of openings in which components for processing material are fitted, or through which the pipelines or cyclones of other platforms 14 extend, for example. The platform 14 furthermore preferably comprises components for processing or transporting material or air, such as, for example, a cyclone 28 or a plurality of pipelines 34 which direct material 5 into the cyclone 28 or out of the latter. The platform 14 preferably has at least one cyclone 28 and one base plate 36, wherein the cyclone 28 is fastened to the base plate 36.

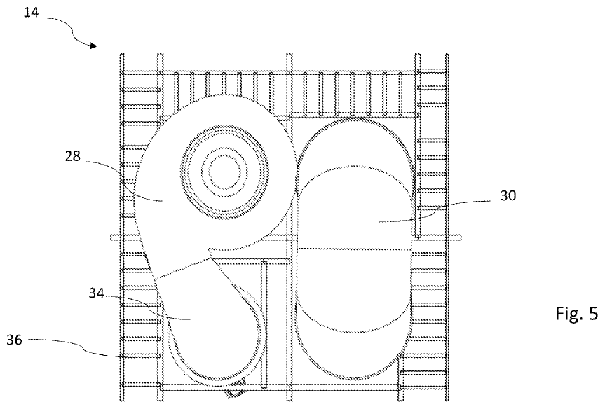

FIG. 4 by way of example additionally shows the upper end of the calciner 30, wherein the disposal of the cyclone 28 and of the part of the calciner 30 is likewise illustrated in FIG. 5. FIG. 5 shows the platform 14 of FIG. 4 in a plan view.

During the construction of the pre-heating tower 10 at least one or a plurality of platforms 14, for example according to FIGS. 4 and 5, is/are assembled so that cyclones 28, pipelines 34, the calciner 30 and/or the kiln outlet 32 are fitted to a base plate 36. The assembly of the platforms 14 takes place outside the tower structure 12, for example, wherein a plurality of platforms 14 are simultaneously assembled, for example. Subsequently, the platforms 14 are successively pushed laterally into the tower structure 12 below the second floor. The platforms 14 are in each case preferably pushed into the tower structure 12 between the support beams 16a and 16b having the changed cross-sectional profile, because the opening between these support beams 16a and 16b is larger than between the remaining support beams 16 and in particular corresponds substantially to the width of the platform 14. In particular, the height of the assembled platforms having cyclones 28, pipelines 34, the calciner 30 and/or the kiln outlet 32 exceeds the floor height of a floor of the pre-heating tower 10, preferably the vertical spacing of two adjacent mounting positions of the tower structure 12.

The first of the plurality of platforms 14 within the tower structure 14, preferably means of a lifting device such as, for example, a tackle, is raised as far as an upper, in particular the uppermost, mounting position and fastened to the latter so that the first platform preferably configures an upper, or the uppermost, floor of the pre-heating tower 10. Subsequently, further platforms 14 are gradually pushed into the tower structure 12 in the same way and raised as far as the respective mounting position, wherein the following mounting positions are disposed below the first mounting position and the sequence of mounting the platforms 14 on the tower structure 12 is from the top to the bottom.

It is likewise conceivable that a platform 14 is in each case assembled at ground level within the tower structure 12 and subsequently is raised as far as the respective mounting position and fastened thereto as has been described above. Subsequently, a further platform is assembled at ground level within the tower structure 12 and fastened to a mounting position below the preceding mounting position.

### LIST OF REFERENCE SIGNS

10 Pre-heating tower
12 Tower structure
14 Platform
16 Support beam
18-26 Cross beams
28 Cyclone
30 Calciner
32 Kiln outlet
34 Pipelines
36 Base plate

1.-13. (canceled)

14. A tower structure of a pre-heating tower of a plant for thermally processing minerals, the tower structure comprising:
support beams that extend vertically and parallel to one another, the support beams being connected to one another via cross beams; and
mounting positions, each for fitting a platform to the tower structure,
wherein a cross-sectional profile of at least two of the support beams changes over a height of the tower structure,
wherein at least two adjacent support beams of the support beams each have a first cross-sectional profile and a second cross-sectional profile, with the first cross-sectional profiles being configured at a bottom end region of the at least two adjacent support beams, wherein the first cross-sectional profiles are configured such that an amount of space between the at least two adjacent support beams is greater below a first or second mounting position of the mounting positions than above the first or second mounting position.

15. The tower structure of claim 14 wherein the first cross-sectional profiles are disposed below the first mounting position.

16. The tower structure of claim 14 wherein the first cross-sectional profiles are disposed below the second mounting position.

17. The tower structure of claim 14 wherein a dismountable cross beam of the cross beams is fitted below the second mounting position between the at least two of the support beams with the cross-sectional profile that changes over the height of the tower structure.

18. The tower structure of claim 14 wherein none of the cross beams is fitted below the second mounting position between the at least two of the support beams with the cross-sectional profile that changes over the height of the tower structure.

19. A pre-heating tower of a plant for thermally processing minerals, the pre-heating tower comprising:
a tower structure including:
support beams that extend vertically and parallel to one another, the support beams being connected to one another via cross beams, and
mounting positions, each for fitting a platform to the tower structure,
wherein a cross-sectional profile of at least two of the support beams changes over a height of the tower structure,
wherein at least two adjacent support beams of the support beams each have a first cross-sectional profile and a second cross-sectional profile, with the first cross-sectional profiles being configured at a bottom end region of the at least two adjacent support beams, wherein the first cross-sectional profiles are configured such that an amount of space between the at least two adjacent support beams is greater below a first or second mounting position of the mounting positions than above the first or second mounting position; and
platforms, wherein each platform includes a base plate and a cyclone fitted thereon, wherein in each case one of the platforms is fitted at each of the mounting positions of the tower structure.

20. The pre-heating tower of claim 19 wherein a height of each of the platforms exceeds a vertical spacing between two adjacent of the mounting positions of the tower structure.

21. The pre-heating tower of claim 20 wherein at least one of the platforms includes one of the cross beams, which cross beam is fitted between the at least two of the support beams with the cross-sectional profile that changes over the height of the tower structure.

22. A method for erecting the pre-heating tower of claim 19 of a plant for thermally processing minerals, the method comprising:
erecting or providing the tower structure of claim 19 having the mounting positions for fastening the platforms, with each of the platforms partially or completely configuring a floor of the pre-heating tower;
assembling a first platform of the platforms below a corresponding one of the mounting positions;
raising the first platform that has been assembled up to an upper mounting position;
mounting the first platform at the upper mounting position so that the first platform configures an upper floor of the pre-heating tower;
raising a second platform of the platforms up to a corresponding one of the mounting positions below the first platform; and
mounting the second platform at the corresponding one of the mounting positions for the second platform so that the second platform configures a second floor of the pre-heating tower.

23. The method of claim 22 wherein the assembly of the first platform occurs at a level below a lowermost mounting position.

24. The method of claim 22 wherein the assembly of the first platform occurs at a base level within the tower structure.

25. The method of claim 22 comprising pushing the first platform, once assembled, laterally into the tower structure below the mounting position for the second platform.

26. The method of claim 22 wherein the raising of the first platform occurs within the tower structure.

27. The method of claim 22 wherein assembling the first or second platform comprises mounting a cyclone on a base plate.

28. The method of claim 22 wherein the tower structure is realized by an assembly of profiles composed of steel or concrete so that the tower structure has a wider lateral push-in opening below the mounting position for the second platform than above the mounting position for the second platform.

29. The method of claim 22 wherein the tower structure is realized by an assembly of profiles composed of steel or concrete so that the tower structure has a wider lateral push-in opening below the mounting position for the first platform than above the mounting position for the first platform.
